(19) United States
(12) Patent Application Publication
(10) Pub. No.: US 2014/0059181 A1
(43) Pub. Date: Feb. 27, 2014

(54) DISTRIBUTION OF APPLICATIONS IN A NETWORK

(71) Applicants: Nicolas Bihannic, Trebeurden (FR); Emile Stephan, Ile Grande (FR); Morgan Richomme, Lannion (FR)

(72) Inventors: Nicolas Bihannic, Trebeurden (FR); Emile Stephan, Ile Grande (FR); Morgan Richomme, Lannion (FR)

(73) Assignee: ORANGE, Paris (FR)

(21) Appl. No.: 14/002,042

(22) PCT Filed: Feb. 21, 2012
(86) PCT No.: PCT/FR12/50369

§ 371 Date: Nov. 11, 2013

(30) Foreign Application Priority Data
Feb. 28, 2011 (FR) 1151614

(51) Int. Cl. H04L 29/08

(52) U.S. Cl. CPC H04L 67/10
USPC 709/219

(57) ABSTRACT

A method of distributing applications in a first network destined for user terminals is provided. The method includes downloading an application to a user terminal via a first download server associated with the first network, the downloaded application being stored in an entity within a second network interconnected with the first network. Prior to downloading, the method includes: sending, from the first download server, a message containing rules relating to applications likely to be downloaded by the first download server, to a central control server; receiving, by a second download server associated with the second network, a download request sent from the first download server; sending, by the second download server, a response message to the first download server, the response message including data allowing downloading; and transmitting a message containing information relating to the downloading of the application, from the second download server to the central control server.

### CROSS-REFERENCE TO RELATED APPLICATIONS

This Application is a Section 371 National Stage Application of International Application No. PCT/FR2012/050369, filed Feb. 21, 2012, which is incorporated by reference in its entirety and published as WO 2012/117185 on Sep. 7, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present invention relates in general to the distribution of applications in telecommunications networks.

### BACKGROUND

These days, online platforms created by manufacturers of mobile terminals or of OS (operating systems) are known for allowing the users to download applications. Similarly, the mobile operators have placed in service their own applications-downloading platforms.

Furthermore, the WAC (Wholesale Application Community) consortium has the objective of promoting programming tools and programming interfaces which will be used by the applications developers. Thus, an application developed according to this protocol will be compatible with any platform of the operators who are members of this consortium.

However, for an application to be downloadable in the networks of different operators, the application developer must individually propose it to each operator and each operator must incorporate it into his download platform.

### SUMMARY

An exemplary embodiment of the present application relates to a method for distributing applications in a first network to user terminals, comprising the downloading of an application onto a user terminal via a first download server associated with the first network, the downloaded application being stored in an entity situated in a second network interconnected with the first network, the method comprising the prior steps of:

sending, from the first download server, of a message comprising rules relating to applications capable of being downloaded by the first download server, to a central control server,

reception, by a second download server associated with the second network, of a download request sent from the first download server,

emission, by the second download server, of a response message to the first download server, the response message comprising data allowing the download, and

transmission of a message containing information relating to the downloading of the application, from the second download server to the central control server.

By virtue of the invention, one and the same application can be proposed for downloading in several networks while having been presented to only one network by its developer, while allowing a first network, to which the user terminals are connected, to define the types of applications originating from a second network to which the developer presents applications, which are potentially downloadable from his installations.

Consequently, the users have a larger offer of downloadable applications. The applications developers can propose their applications to a larger number of users. The operators of the networks are capable of increasing their revenues associated with the downloading of applications. Thus, each of the various players involved in the downloading of applications benefits from the use of the invention.

According to one preferred feature, the method also comprises a step of transmission of a message containing information relating to the downloading of the application from the first download server to the central control server.

The central control server thus knows of the download based on the information transmitted by the two download servers involved. This makes it possible to validate this information.

According to one preferred feature, the information relating to the downloading of the application comprises at least one identifier of the application, one identifier of the network with which the first download server is associated and one identifier of the network with which the second download server is associated.

This information is useful for correctly accounting for the download that has taken place.

According to one preferred feature, the method comprises the sending, by the second download server, of a list of applications that are capable of being downloaded by the first download server and of metadata respectively associated with each of the applications, to the central control server. For example, the metadata associated with the application are the description of the application but also data relating to the popularity of the application. A more exhaustive list of these data is given hereinafter.

Thus, the second network can define the applications that originate from the second network and that are potentially downloadable from the first network.

According to one preferred feature, the method comprises the selection by the central control server of a subset of applications from the list of applications, as a function of the rules relating to the applications that are capable of being downloaded by the first download server.

The central control server therefore filters the applications originating from the second network and that are downloadable from the first network.

According to one preferred feature, the method comprises the sending of the applications selected by the central control server to the first download server.

According to another preferred feature, the method comprises, following the reception by a central transaction server of a publication message emitted by the central control server, the sending by the central transaction server of a message indicating a financial transfer to be made to the first and/or the second download server, which makes it possible to inform the end user and/or the distributor of such a financial transfer.

The invention also relates to a server for downloading applications in a second network to user terminals,

characterized in that, for an application stored in an entity situated in the second network interconnected with a first network, the download server comprises:

means for receiving a download request sent from a first download server associated with the first network,

means for emitting a response message to the first download server, the response message comprising data allowing the download, and

means for transmitting a message containing information relating to the downloading of the application to a central control server.

The invention also relates to a server for downloading applications in a first network to user terminals, suitable for interacting with a server as explained above,

characterized in that, for an application stored in an entity situated in the second network interconnected with a first network, the download server comprises:

means for emitting a download request to the download server associated with the second network,

means for receiving a response message from the download server associated with the second network, the response message comprising data allowing the download.

The invention also relates to a central control server for the downloading of an application in a first network, said application being stored in a second network, characterized in that it comprises means for receiving a message containing information relating to the downloading of the application.

The invention also relates to a system comprising at least download servers as explained above and a central control server as explained above.

In particular, the invention relates to a system comprising at least one download server in a second network as explained above and one central control server as explained above. In other words, the central control server is advantageously physically co-located with the download server in a second network, within one and the same system which may be a single server, in order to gain in speed and to reduce the costs relating to storage.

These various devices have advantages similar to those of the method explained above.

In one particular embodiment, the various steps of the method according to the invention are determined by computer-program instructions.

Consequently, a further subject of the invention is a computer program on an information medium, this program being capable of being used in a computer, this program comprising instructions suitable for the implementation of the steps of a method as described above.

This program can use any programming language and be in the form of source code, object code, or intermediate code between source code and object code, such as in a partially compiled form, or in any other desirable form.

A further subject of the invention is an information medium that can be read by a computer and comprises computer-program instructions as mentioned above.

The information medium may be any entity or device capable of storing the program. For example, the medium may comprise a storage means such as a ROM, for example a CD ROM or a microelectronic-circuit ROM, or else a magnetic recording medium, for example a floppy disk or a hard disk.

Furthermore, the information medium may be a transmissible medium such as an electrical or optical signal, which may be carried via an electrical or optical cable, by radio or by other means. The program according to the invention may in particular be downloaded on a network of the Internet type.

Alternatively, the information medium may be an integrated circuit in which the program is incorporated, the circuit being suitable for executing or for being used in the execution of the method in question.

### BRIEF DESCRIPTION OF THE DRAWINGS

Other features and advantages will become apparent on reading preferred embodiments described with reference to the figures in which:

FIG. 1 represents schematically the various entities of two networks implementing the invention,

FIG. 2 represents steps prior to an application download, according to the invention,

FIG. 3 represents a first embodiment of application downloading by a user terminal, according to the invention,

FIG. 4 represents a second embodiment of application downloading by a user terminal, according to the invention,

FIG. 5 represents a third embodiment of application downloading by a user terminal, according to the invention, and

FIG. 6 represents the steps carried out after the application downloading by a user terminal, according to the invention.

### DETAILED DESCRIPTION OF ILLUSTRATIVE EMBODIMENTS

The subject here is the downloading of applications on user terminals. Therefore only the entities involved in this downloading are described.

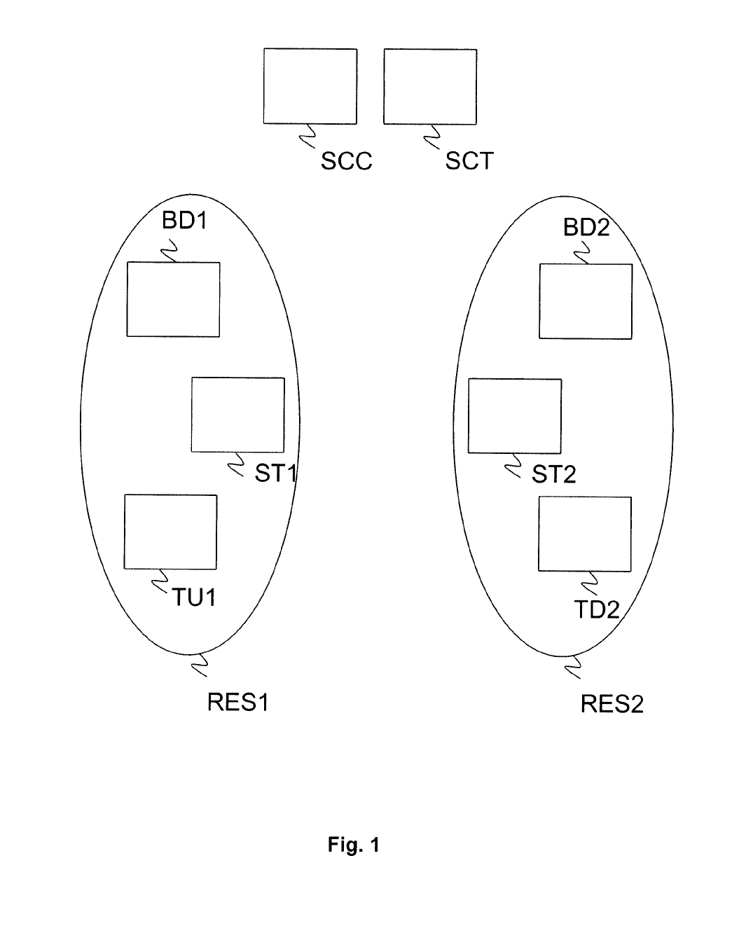

According to one embodiment of the invention shown in FIG. 1, a first telecommunications network RES1 comprises user terminals, of which only one TU1 is shown. The user terminal TU1 is for example a telephone or a computer. Conventionally it comprises a processor, a read-only memory, a random-access memory and communication means, notably for communicating with a download server ST1 also situated in the network RES1. The download server ST1 has the conventional structure of a computer and comprises a processor, a read-only memory, a random-access memory and communication means. The network RES1 also comprises a storage entity, for example a database BD1. The database BD1 has the structure of a computer and comprises a processor, a read-only memory, a random-access memory and communication means.

A second telecommunications network RES2 comprises a terminal called a developer terminal TD2, which is a terminal offering one or more applications for downloading. The developer terminal TD2 is for example a computer. Conventionally it comprises a processor, a read-only memory, a random-access memory and communication means, notably for communicating with a download server ST2 also situated in the network RES2. The download server ST2 has the conventional structure of a computer and comprises a processor, a read-only memory, a random-access memory and communication means. The network RES2 also comprises a storage entity, for example a database BD2. The database BD2 has the structure of a computer and comprises a processor, a read-only memory, a random-access memory and communication means.

The networks RES1 and RES2 are interconnected. They are for example cellphone networks, of the GPRS or UMTS or else EPS (Evolved Packet System) type. The networks RES1 and RES2 are for example the networks of two different operators which may or may not cover the same territory. It should be noted that for one of these networks at least, the download servers and the databases may be implemented according to a technology of the CDN (Content Delivery Network) type. A network of CDN type also uses a function, called Request Routing, for optimization of the distribution of the applications within the network according to the profiles, contexts and expectations of the user, the network, the servers and the databases. The networks of CDN type are designed to be interconnected. In this case, they exploit the data interchanged with the central server SCC in order to select the applications to be recommended to the users and the network most capable of distributing the chosen application, according to a criterion of proximity or of cost or of optimization of the bandwidth, for example.

A central control server SCC and a central transaction server SCT are used in the context of the invention, as explained hereinafter. These servers each have the conventional structure of a computer. Therefore, they each comprise a processor, a read-only memory, a random-access memory and communication means.

For example, the central control server SCC is the entity called “Data Clearing House” and the central transaction server is the entity called “Data Financial House” of a system used for controlling the financial transfers associated with roaming of cellphone terminals between the networks RES1 and RES2. In one particular embodiment, the central control server SCC is physically co-located with the download server ST2 within the second telecommunications network RES2 (for example within a single server), which makes it possible to gain in processing speed and to reduce the costs associated with storage.

Naturally, the number of networks can be more than two.

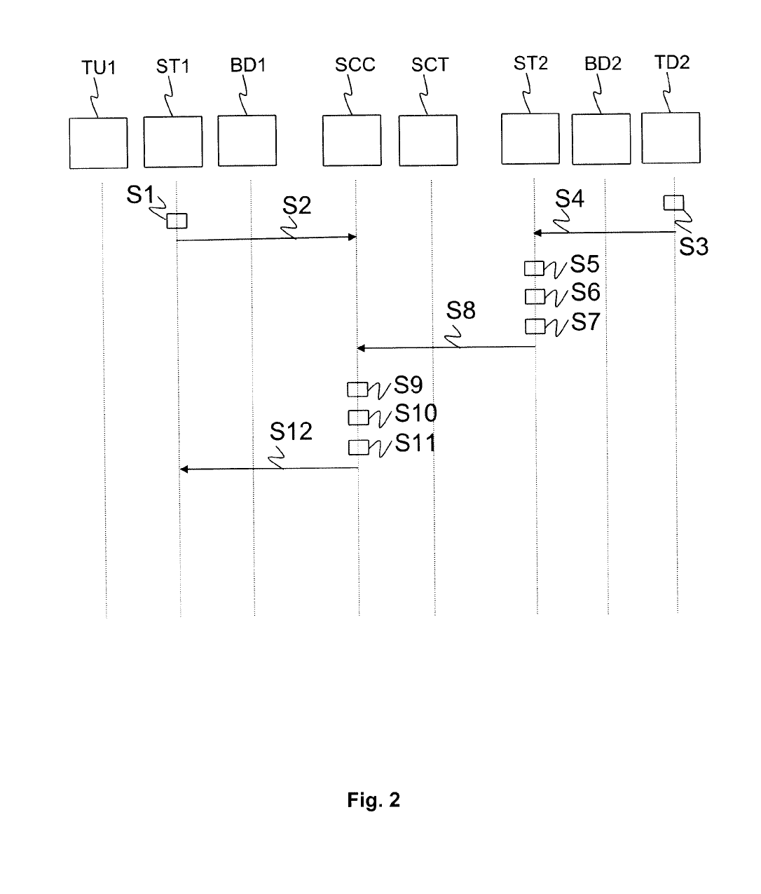

The interactions between the various entities involved for the downloading of an application by the user terminal TU1 will now be explained in detail with the aid of the flowcharts of FIGS. 2 to 6.

In what follows, it is assumed that the network RES2 is the source network of the application and that the terminal consuming this application is in the network RES1. Naturally, each of the networks may be the source and the consumer with respect to the other.

According to one embodiment of the invention shown in FIG. 2, the download server ST1 produces a periodic edition S1 of the policies, or rules, which govern inter-network downloading. An edition, or update, of the policies comprises an identifier of the network RES1 and notification criteria such as:

preferred types, corresponding to the topics of the applications, such as games, music, sport, for example,

preferred categories, corresponding to a classification of the application depending on the nature of its content, for example, “general release” or “not for those under 12 years of age”, for example,

the price,

the language,

the desired popularity,

the compatibility with the range of terminals of the network,

the preferred partner networks,

the storage-type preference.

The storage-type preference allows the download server ST1 to specify its preferences with respect to the mode of storing, and consequently of downloading, the applications.

Once the policies are published, the download server ST1 exports them (S2) to the central control server SCC. This sending S2 is therefore also periodic.

The notification criteria of the network RES1 will allow the central control server SCC to select the applications that will be proposed to the network RES1. Ultimately, the selected applications will be offered to the users of the terminals of the network RES1.

It is assumed that the developer terminal TD2 has developed a new application. During a step S3, it publishes the metadata associated with this application. The metadata of an application comprise a developer identifier and the following information:

an identifier of the application,

the application type,

the application category,

the application price,

the application language,

the application version,

the memory space required by the application,

the compatibility of the application with the various types of terminals,

the storage preferences of the application.

The storage preferences of the application allow the developer to specify whether he prefers for his application to be exploited from his own terminal TD2 or in a storage entity of the network RES2 or else in each network capable of offering his application for download to its users.

Step S3 is followed by step S4 during which the developer terminal TD2 sends the application and the metadata of the application to the download server ST2.

In the next step S5, the download server ST2 updates the list of applications accessible to the users of the network RES2, incorporating therein the application that is the subject of step S4.

Step S5 is followed by step S6 in which the download server ST2 selects the applications to be exported to the network RES1. This selection is carried out on the basis of the usages in the network RES2. It should be noted that the download server ST2 may also withdraw an application that it has previously exported to the network RES1.

The next step S7 is the publishing of the metadata relating to each of the applications selected in the previous step. The metadata of an application include those that have been sent in step S4 and received by the download server ST2. Moreover, the download server ST2 adds thereto information on the popularity of the application, based on the number of downloads of this application in the network RES2, that is to say from the download server ST2.

The download server ST2 also adds an identifier of the source network RES2. It may also add a rule for payment of the developer, for example a ratio of transfer of the application purchase price to its developer.

The following step S8 is the publication of the applications and of their associated metadata to the central control server SCC.

After these data have been received, the central control server SCC stores them in step S9.

The next step S10 is the analysis of the application metadata previously received and the policies of the network RES1 that have been sent in step S2. The comparison of these two data sets is used to determine the applications originating from the network RES2 that can be offered in the network RES1.

In the next step S11, the metadata of the applications selected in step S10 are published by the central control server SCC. For example, the central control server may delete the ratio of transfer of the application purchase price to its developer so that the download server ST1 has no knowledge of it. There is therefore filtering of the information that is supplied to the network RES1. Moreover, the central control server SCC may add information, for example the total number of downloads of the application through the various networks connected to the central control server SCC.

In the next step S12, the selected applications and their associated metadata are published by the central control server to the download server ST1. In other words, the central control server SCC sends the selected applications and their metadata to the download server ST1 so that the latter can then present them to the users of the terminals of the network RES1.

It is now assumed that the user of the terminal TU1 selects an application originating from the network RES2 in step S13.

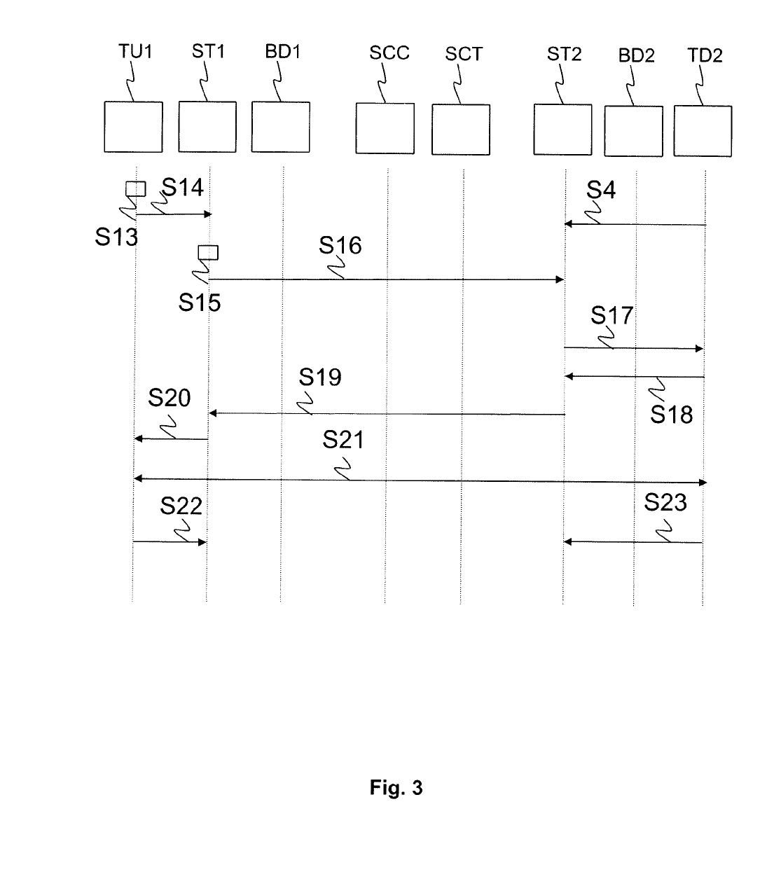

With reference to FIG. 3, a first embodiment corresponds to the case in which the application in question is stored in the terminal of the developer TD2.

Step S14 is the sending from the terminal TU1 to the download server ST1 of a request to obtain the application.

The next step S15 is the analysis of this request by the download server ST1. The storage preferences of the application are also analyzed.

It is assumed in this first embodiment that the application is stored in the terminal of the developer TD2.

The next step S16 is the sending by the download server ST1 of a request to obtain the application to the download server ST2. The request includes an identifier of the network RES1.

After having received this request, the download server ST2 sends to the terminal TD2 a download request for the application, in step S17.

The terminal TD2 responds to this request with an acceptance message in step S18.

In the next step S19, the download server ST2 sends to the download server ST1 a message containing the download address, in the form of a URL (Uniform Resource Locator) address.

The download server ST1 in its turn sends to the user terminal TU1 a message containing the download address, in step S20.

The next step S21 is the actual downloading of the application, from the developer terminal TD2 to the user terminal TU1.

Step S21 is followed by step S22 in which the user terminal TU1 sends a notification of end of download to the download server ST1.

Similarly, the developer terminal TD2 sends a notification of end of download to the download server ST2, in step S23.

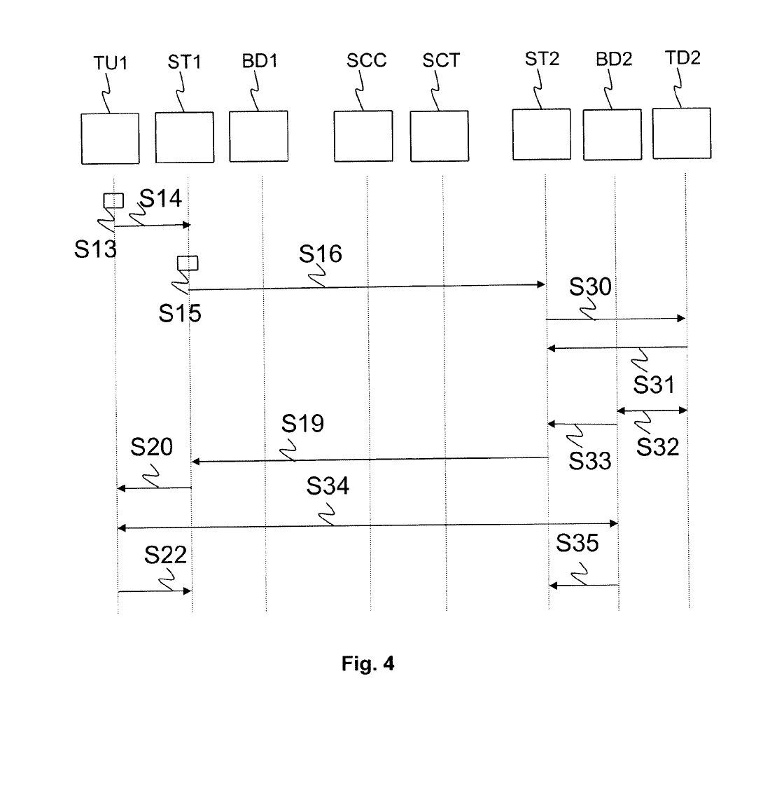

With reference to FIG. 4, a second embodiment corresponds to the case in which the application in question is stored in a database BD2 situated in the network RES2.

This embodiment comprises steps S13 to S16 which are identical to those described with reference to the previous figure.

The terminal TU1 selects an application originating from the network RES2 in step S13.

Step S14 is the sending from the terminal TU1 to the download server ST1 of a request to obtain the application.

The next step S15 is the analysis of this request by the download server ST1. The storage preferences of the application are also analyzed.

It is assumed in this second embodiment that the application is stored in the database BD2.

The next step S16 is the sending by the download server ST1 of a request to obtain the application to the download server ST2. The request includes an identifier of the network RES1.

If the application has not previously been stored in the database BD2, steps S30 to S33 are carried out.

In step S30, the download server ST2 sends to the terminal TD2 a download request for the application.

The terminal TD2 responds to this request with an acceptance message in step S31.

In the next step S32, the terminal TD2 downloads the application to the database BD2.

In the next step S33, the database BD2 sends a message to the download server ST2 to give it the download address of the application.

Step S33 is followed by step S19.

If the application has previously been stored in the database BD2, that is to say if steps S30 to S33 have already been carried out for a previous download, they are not repeated and step S16 is followed directly by step S19.

The next steps S19 and S20 are identical to those previously described with reference to FIG. 3.

In the next step S19, the download server ST2 sends to the download server ST1 a message containing the download address, in the form of a URL (Uniform Resource Locator) address.

The download server ST1 in its turn sends to the user terminal TU1 a message containing the download address, in step S20.

The next step S34 is the actual downloading of the application, from the database BD2 to the user terminal TU1.

Step S34 is followed by step S22 in which the user terminal TU1 sends a notification of end of download to the download server ST1.

Similarly, the database BD2 sends a notification of end of download to the download server ST2, in step S35.

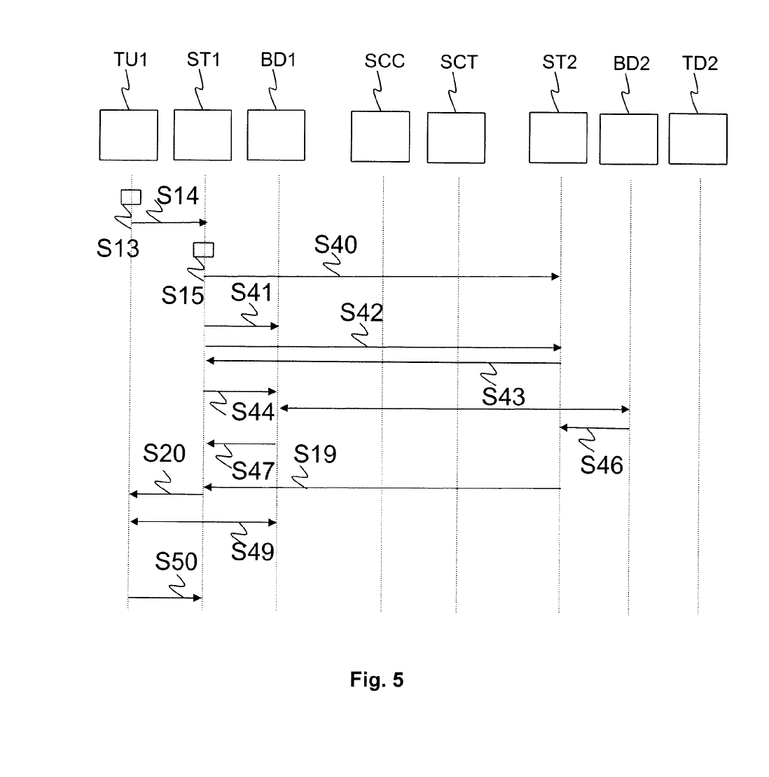

With reference to FIG. 5, a third embodiment corresponds to the case in which the application in question is stored in a database BD1 situated in the network RES1. Provision is made for the case in which the application is not initially stored in the network RES1 and must therefore be downloaded once from the network RES2 to the network RES1.

This embodiment comprises steps S13 to S15 which are identical to those described with reference to FIG. 3.

The terminal TU1 selects an application originating from the network RES2 in step S13.

Step S14 is the sending from the terminal TU1 to the download server ST1 of a request to obtain the application.

The next step S15 is the analysis of this request by the download server ST1. The storage preferences of the application are also analyzed.

It is assumed in this third embodiment that the application is stored in the database BD1 while envisaging the possibility that, during the first download, it fails to download the application from the network RES2 to the network RES1.

The next step S40 is the sending by the download server ST1 of a message to signal the request to obtain the application, to the download server ST2. The message includes an identifier of the network RES1.

The next step S41 is the sending by the download server ST1 of a request to obtain the application, to the database BD1.

If the application has not previously been stored in the database BD1, steps S42 to S47 are carried out. It is assumed here that the application is stored in the database BD2 of the network RES2.

In step S42, the download server ST1 sends to the download server ST2 a download request for the application.

The download server ST2 responds to this request by sending to the download server ST1 a message containing the download address of the application, in step S43.

In the next step S44, the download server ST1 sends the download address of the application to the database BD1.

The next step S45 is the actual downloading of the application from the database BD2 to the database BD1.

Step S45 is followed by step S46 in which the database BD2 sends a notification of end of download to the download server ST2.

Similarly, the database BD1 sends a notification of end of download to the download server ST1, in step S47.

Step S47 is followed by step S20.

If the application has previously been stored in the database BD1, that is to say if steps S42 to S47 have already been carried out for a previous download, they are not repeated and step S41 is followed directly by step S20.

In step S20, identical to that described with reference to FIG. 3, the download server ST1 sends to the user terminal TU1 a message containing the download address.

The next step S49 is the actual downloading of the application, from the database BD1 to the user terminal TU1.

Step S49 is followed by step S50 in which the user terminal TU1 sends a notification of end of download to the download server ST1.

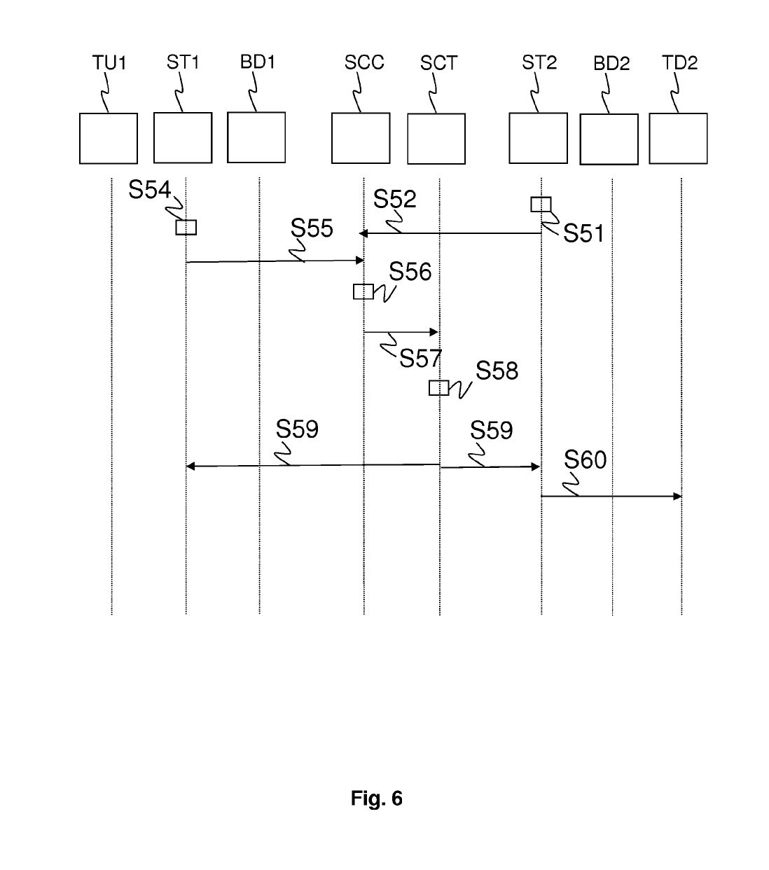

With reference to FIG. 6, the interchanges between the download servers ST1 and ST2 and the central control server SCC will now be described.

Step S51 is the generation by the download server ST2 of a message comprising information relating to the downloading of the application. This information comprises at least one identifier of the application, one identifier of the network with which the download server is associated, in this instance the network RES2, and one identifier of the network that has received the download, in this instance the network RES1.

Preferably, the message is a message of the TAP (Transferred Account Procedure record) type, as defined in the GSMA (GSM Association), modified according to the invention in order to be enhanced with information relating to the downloading of the application.

Conventionally, a TAP record comprises all the information relating to a transaction for a user terminal when roaming. A TAP record allows the calculation of a transfer between operators. The invention therefore proposes to enhance the TAP record and to use it for the distribution of applications between networks, even when the user terminal is not roaming.

The next step S52 is the sending by the download server ST2 of the message comprising information relating to the downloading of the application to the central control server SCC.

The download server ST2 may also send a download notification to the developer terminal TD2 irrespective of the method of achieving the download.

The download server ST1 may also generate a message comprising information relating to the downloading of the application in step S54. This information comprises at least one identifier of the application and one identifier of the network with which the download server is associated, in this instance the network RES1.

The message has the same structure as the message generated in step S51.

The download server ST1 sends the message comprising information relating to the downloading of the application to the central control server SCC, in the next step S55.

In the next step S56, the central control server SCC takes account of the message(s) received from the download server(s) for a given download. It aggregates the information received and sends a publication message to the central transaction server SCT in step S57. This sending may be carried out periodically and then includes all the downloads carried out during the elapsed period.

The central transaction server SCT defines, in step S58, which financial transfer must be carried out to which network. In step S59, it sends a message to the download server(s) concerned to indicate the result of the previous step. Step S59 may be carried out periodically according to a period which may be longer than that of step S57.

In step S60, the download server indicates to the developer terminal TD2 that a financial transfer has been allocated to it following the download of the application by the user terminal TU1 or following an agreed condition. Specifically, steps S56 to S60 may be initiated periodically or according to agreed conditions, for example when a predetermined number of downloads of the application is reached.

1. A method for distributing applications in a first network to user terminals, comprising:
downloading an application onto a user terminal via a first download server associated with the first network, the downloaded application being stored in an entity situated in a second network interconnected with the first network,
the method further comprising the following steps performed prior to downloading:
sending, from the first download server to a central control server, a message comprising rules relating to the applications that are capable of being downloaded in the first network,
publication, by the central control server to the first download server, of a subset of applications stored in the entity situated in the second network, selected as a function of said rules,
reception, by a second download server associated with the second network, of a download request relating to one of said published applications, sent from the first download server, and
emission, by the second download server, of a response message to the first download server, the response message comprising data allowing the download of said requested application.

2. The method as claimed in claim 1, wherein the method further comprises a step of transmission of a message containing information relating to the downloading of the application from the first download server to the central control server.

3. The method as claimed in claim 1, wherein the information relating to the downloading of the application comprises at least one identifier of the application, at least one identifier of the network with which the first download server is associated and at least one identifier of the network with which the second download server is associated.

4. The method as claimed in claim 1, wherein the method comprises sending, by the second download server, a list of applications that are capable of being downloaded by the first download server and metadata respectively associated with each of the applications, to the central control server.

5. The method as claimed in claim 1, wherein the method comprises selection by the central control server of a subset of applications from the list of applications, as a function of the rules relating to the applications that are capable of being downloaded by the first download server.

6. The method as claimed in claim 5, wherein the method comprises transmission of a message containing information relating to the downloading of the application from the second download server to the central control server.

7. The method as claimed in claim 1, wherein the method comprises, following the reception by a central transaction server of a publication message emitted by the central control server, the sending by the central transaction server of a message indicating a financial transfer to be made to the first and/or the second download server.

8. A server for downloading applications in a second network to user terminals,
wherein, for an application stored in an entity situated in the second network interconnected with a first network, the server for downloading comprises
means for publication, to a central control server, of a list of applications suitable for being exported to the first network,
means for receiving a download request, relating to one of the applications of said list, sent from a first download server associated with the first network, and
means for emitting a response message to the first download server, the response message comprising data allowing the download of said application.

9. A server for downloading applications in a first network to user terminals,
wherein the server comprises:
means for emitting, to a central control server, a message comprising rules relating to applications suitable for being downloaded in the first network, and for emitting a download request, relating to one of said applications, to a download server of the second network,
means for receiving, from said central control server, a subset of applications stored in an entity, which is situated in a second network interconnected with the first network, the subset of applications being selected as a function of said related rules, and for receiving a response message, from the download server of the second network, the response message comprising data allowing the download of said application.

10. A central control server for downloading an application in a first network, said application being stored in a second network, wherein the central control server comprises:
reception means for receiving, from a download server of the first network, a message comprising rules relating to the applications suitable for being downloaded in the first network and for receiving, from a download server of the second network, a list of applications stored in the second network and suitable for being exported to the first network,
means for publishing, to the download server of the first network, a subset of applications selected in said list as a function of said rules.

11. A system comprising:
a second download server for downloading applications in a second network to user terminals, wherein, for an application stored in an entity situated in the second network interconnected with a first network, the second download server comprises:
means for publication, to a central control server, of a list of applications suitable for being exported to the first network,
means for receiving a download request, relating to one of the applications of said list, sent from a first download server associated with the first network, and
means for emitting a response message to the first download server, the response message comprising data allowing the download of said application; and
the central control server for downloading an application being stored in the second network, wherein the central control server comprises:
reception means for receiving, from a download server of the first network, a message comprising rules relating to the applications suitable for being downloaded in the first network and for receiving, from the download server of the second network, the list of applications stored in the second network and suitable for being exported to the first network, and
means for publishing, to the first download server of the first network, a subset of applications selected in said list as a function of said rules.

12. The system as claimed in claim 11, wherein the system further comprises:
the first download server of the first network, wherein the first download server comprises:
means for emitting, to the central control server, the message comprising the rules relating to applications suitable for being downloaded in the first network, and for emitting the download request, relating to one of said applications, to the second download server of the second network, and
means for receiving, from said central control server, the subset of applications stored in the entity situated in the second network, and for receiving the response message, from the second download server.

13. (canceled)

14. A non-transmissible computer-readable recording medium on which is recorded a computer program comprising instructions for execution of a method for distributing applications in a first network to user terminals, comprising:
downloading an application onto a user terminal via a first download server associated with the first network, the downloaded application being stored in an entity) situated in a second network interconnected with the first network,
the method further comprising the following steps performed prior to downloading:
sending, from the first download server to a central control server, a message comprising rules relating to the applications that are capable of being downloaded in the first network,
publication, by the central control server to the first download server, of a subset of applications stored in the entity situated in the second network, selected as a function of said rules,
reception, by a second download server associated with the second network, of a download request relating to one of said published applications, sent from the first download server, and
emission, by the second download server, of a response message to the first download server, the response message comprising data allowing the download of said requested application.
